(19) United States
(12) Patent Application Publication
(10) Pub. No.: US 2015/0150077 A1
(43) Pub. Date: May 28, 2015

(54) TERMINAL DEVICE, MAIL DISTRIBUTION SYSTEM, AND SECURITY CHECK METHOD

(71) Applicant: BIGLOBE INC., TOKYO (JP)

(72) Inventor: Hideaki Daimon, Tokyo (JP)

(73) Assignee: BIGLOBE INC., TOKYO (JP)

(21) Appl. No.: 14/547,824

(22) Filed: Nov. 19, 2014

(30) Foreign Application Priority Data
Nov. 26, 2013 (JP) 2013-243994

(51) Int. Cl. H04L 29/06; G06F 3/0481

(52) U.S. Cl. CPC H04L 63/20; G06F 3/0481; H04L 63/08
USPC 726/1

(57) ABSTRACT

To check the security of a link destination described in an electronic mail without the necessity of access operation on the link destination, A terminal device according to the present invention, when operation on a user interface satisfies a predetermined first condition different from operation, of instructing connection to a WEB site, requests test of the security of a link destination indicated by first link information contained in an electronic mail text, and then displays information corresponding to the test result in a manner permitting visual recognition together with second link information indicating another link destination which is different from that of the first link information.

### BACKGROUND OF THE INVENTION

1. Field of the Invention

The present invention relates to a terminal device, a mail distribution system, and a security check method and, in particular, to a terminal device, a mail distribution system, and a security check method capable of checking the security of a link destination included in an electronic mail text.

2. Related Art

A technique is known that information (referred to as link information, hereinafter) indicating a link destination is displayed in the inside of a text of an electronic mail so that access to the link destination is guided. Such link information can guide users to a desired WEB (World Wide Web) site and hence is preferably used in an advertisement by a company or the like.

On the other hand, so-called phishing fraud is known that link information of a legitimate company is imitated so that users are guided to a fake WEB site different from that of the legitimate company and then personal information or IDs and passwords concerning bank accounts or the like axe stolen. In a typical technique of phishing fraud, an electronic mail imitating a notification from a credit card company, a bank, or the like is sent to a user and then the user is guided to a fake WEB site through the link information displayed in the electronic mail. In the fake WEB site, the user is guided to input the account number and the password of a credit card, a bank account, or the like so that the information is stolen by a third person.

A technique of preventing such phishing fraud is described, for example, in Japanese Laid-Open Patent Publication No. 2007-287124 (Patent Document 1).

In the system described in Patent Document 1, the Internet address of a WEB site desired to be connected is analyzed. Then, when the address is an address implying low reliability, a message window for address checking is displayed. Further, when connection to a WEB site having a similar address to a well-known. WEB site is tried, a message window is displayed in which the user is warned of a possibility of being a phishing WEB site and then whether the site is actually to be connected or not can be selected by the user.

### SUMMARY OF THE INVENTION

In the system described in Patent Document 1, the processing of testing the reliability of a WEB site is performed by the user PC. Thus, the user PC need acquire information concerning secure sites. Patent Document 1 illustrates a technique that information concerning secure sites is acquired at each time of connection to the Internet. Further, in the system described in Patent Document 1, test of reliability is performed with adopting, as a trigger, connection operation to a WEB site. That is, in order that the reliability of a WEB site may be tested, access operation such as inputting of the address of the WEB site and clicking or the like of a hyperlink is necessary. In this case, when not to access is decided because of low reliability of the WEB site, the operation of connection to the WEB site becomes fruitless.

In view of such situations, an object of the present invention is to provide a terminal device, a mail distribution system, and a security check method capable of checking the security of a link destination described in an electronic mail without the necessity of access operation to the link destination.

A terminal device according to the present invention includes a control section for, when operation on a user interface satisfies a predetermined first condition different from operation of instructing connection to a WEB site, requesting a security server to test security of a link destination indicated by first link information contained in an electronic mail text. From plural pieces of display information, the control section selects display information corresponding to a security test result obtained in response to the request by the security server. Further, the control section displays the selected display information in a manner permitting visual recognition together with second link information indicating another link destination which is different from the link destination indicated by the first link information.

A mail distribution system according to the present invention includes: a WEB mail server in which user information is registered; and a terminal device authenticated on the basis of the user information by the WEB mail server. The terminal device includes a control section for, when operation on a user interface satisfies a predetermined first condition different from operation of instructing connection to a WEB site, requesting a security server to test security of a link destination indicated by first link information contained in an electronic mail text. From plural pieces of display information, the control section selects display information corresponding to a security test result transmitted from the security server in response to the request. Further, the control section displays the selected display information in a manner permitting visual recognition together with second link information indicating another link destination which is different from the link destination indicated by the first link information.

A WEB mail server according to the present invention includes a screen generation section for generating screen information used for displaying an electronic mail. The screen generation section transmits to a terminal device, in a manner of being attached to the screen information, a program for causing the terminal device to execute the following operation (1) and (2).

(1) When operation on a user interface of the terminal device satisfies a predetermined first condition different from operation of instructing connection to a WEB sits, request a security server to test security of a link destination indicated by first link information contained in an electronic mail text.

(2) From plural pieces of display information, select display information corresponding to a security test result obtained in response to the request by the security server, and then display the selected display information in a manner permitting visual recognition on the terminal device together with second link information indicating another link destination which is different from the link destination indicated by the first link information.

A security check method according to the present invention includes: a step of, when operation on a user interface satisfies a predetermined first condition different from operation of instructing connection to a WEB site, requesting a security server to test security of a link destination indicated by first link information contained in an electronic mail text; and a step of selecting, from plural pieces of display information, display information corresponding to a security test result obtained in response to the request by the security server and then displaying the selected display information in a manner permitting visual recognition together with second link information indicating another link destination which is different from the link destination indicated by the first link information.

It is preferable that a security check method according to the present invention is implemented by a program stored in a storage device and then executed on a computer.

According to the present invention, the security of a link destination described in an electronic mail can be checked without the necessity of access operation to the link destination.

### BRIEF DESCRIPTION OF THE DRAWINGS

FIG. 1 is a diagram showing an example of configuration of a mail distribution system according to an embodiment of the present invention.

FIG. 2 is a diagram showing an example of configuration of a terminal device according to an embodiment of the present invention.

FIG. 3 is a diagram showing an example of configuration of a WEB mail server according to an embodiment of the present invention.

FIG. 4 is a diagram showing an example of structure of user information recorded in a user information database according to an embodiment.

FIG. 5 is a diagram showing a modification of display mode indicating a security level according to an embodiment.

FIG. 6 is a sequence diagram showing an example of mail distribution operation and security test operation according to an embodiment.

FIG. 7 is a diagram showing an example of a login screen according to the present invention.

FIG. 8 is a diagram showing an example of a received mail list screen according to the present invention.

FIG. 9 is a diagram showing an example of a mail text display screen according to the present invention.

FIG. 10 is a diagram showing an example of test result information displayed on a mail text according to the present invention.

FIG. 11 is a diagram showing another example of test result information displayed on a mail text according to the present invention.

FIG. 12 is a diagram showing yet another example of test result information displayed on a mail text according to the present invention.

FIG. 13 is a diagram showing an example of test result information displayed on a received mail list screen according to the present invention.

### DESCRIPTION OF THE EMBODIMENTS

### Outline

With adopting predetermined operation on an interface as a trigger, a terminal device 10 according to the present invention requests the security server 70 to test the security (also referred to as the reliability) of a WEB (World Wide Web) site that can be accessed through link information contained in a WEB mail text. Further, the terminal device 10 displays in a manner permitting visual recognition the test result acquired from the security server 70. At that time, it is preferable that in addition to text data indicating the contents of the test result, security level display information (such as a symbol) corresponding to the security level of a WEB site and link information (such as a URL: Uniform Resource Locator) used for guiding the user to a site relevant to a security service are displayed as a test result. Further, it is preferable that the security level display information is changed in accordance with a predetermined condition (such as a time condition) for the purpose of avoiding decrease in the user's attentiveness to the information.

An embodiment of the present invention is described below with reference to the accompanying drawings. The same or like reference numerals in the drawings Indicate the same, like, or equivalent components. As methods of browsing an electronic mail (including a short message; this holds also In the following description), in addition to a method of downloading a received mail from a mail server and then browsing the mail, a method is known of making connection through a browser to a WEB mail server on the Internet and then browsing the mail stored in (a storage section of) the mail server. In general, an electronic mail browsed by accessing a WEB mail server is referred to as a WEB mail. In the following description, a mail distribution system according to the present invention is described with adopting an example a mail distribution system that distributes WEB mails.

### Configuration of Mail Distribution System

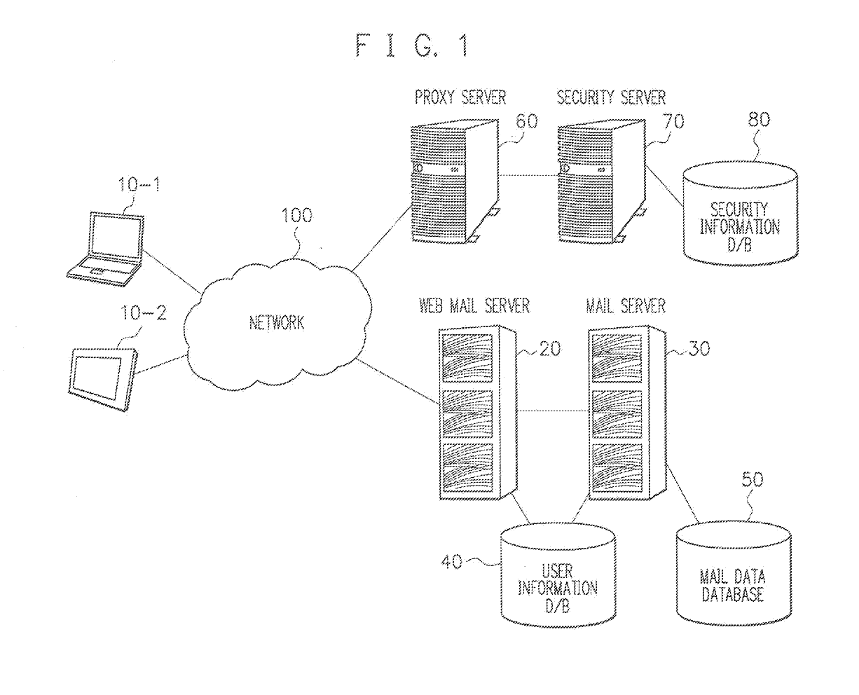

FIG. 1 is a diagram showing an example of configuration of a mail distribution system according to an embodiment of the present invention. As shown in FIG. 1, the mail distribution system includes a terminal device 10, a WEB mail server 20, a mail server 30, a user information database 40 (referred to as a user information D/B 40, hereinafter), a mail data database 50 (referred to as a mail data D/B 50, hereinafter), a proxy server 60, a security server 70, and a security information database 80 (referred to as a security information D/B 80, hereinafter).

The terminal device 10 is a computer device connected to the WEB mail server 20 through a network 100 such as the Internet. The terminal device 10 is connected through the network 100 and the proxy server 60 to the security server 70. The proxy server 60 may be omitted. That is, the terminal device 10 may be directly connected to the security server 70 through the network 100. Alternatively, the terminal device 10 and the security server 70 may be connected to each other through a dedicated line (not shown).

The terminal device 10 receives mail service from the WEB mail server 20 through a WEB browser. It is preferable that a plurality of the terminal devices 10 are provided in correspondence to the number of users using the mail service. However, employable configurations are not limited to this. For example, a single user may use a plurality of terminal devices 10 and a single the terminal device 10 may be shared and used by a plurality of users. The user undergoes authentication by inputting authentication information such as a user ID 41 and a password 42 into the WEB mail server 20 through the terminal device 10. As a result, the user using the terminal device 10 having passed the authentication is allowed to receive the mail service corresponding to oneself. The terminal device 10 is preferably implemented by a portable computer such as a notebook computer 10-1 and a tablet computer 10-2, a portable phone having a network connection function (not shown), a desktop computer, or a server.

The terminal device 10 according to the present invention displays display screen data of a WEB mail through a WEB browser. At that time, with adopting as a trigger an event that operation set forth in a JavaScript program (registered trademark; this description is omitted in the following) is performed on a user interface, the terminal device 10 inquires of the security server 70 about the security of a WEB site or the like (a link destination) to be connected in accordance with link information (referred to as first link information, hereinafter) in the mail text. When receiving a test result of the security from the security server 70, the terminal device 10 displays the result on a display device (not shown) in a manner permitting visual recognition. Here, for example, the first link information indicates an identifier such as a URL and an IP address or alternatively a hyperlink to this, which is used for accessing a WEB site (a WEB page), a file, a network, another terminal device 10, or the like.

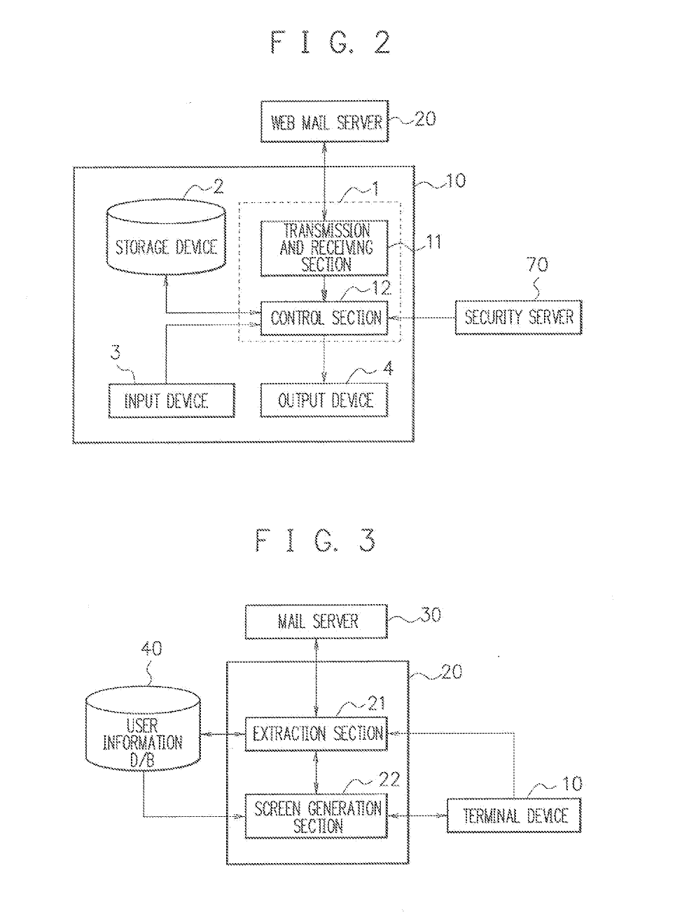

FIG. 2 is a diagram showing an example of configuration of the terminal device 10 according to an embodiment of the present invention. With reference to FIG. 2, the terminal device 10 is a computer device including a CPU 1, a storage device 2, an input device 3, and an output device 4. When a program (a WEB browser) recorded in the storage device 2 is executed by the CPU 1, the function of a transmission and receiving section 11 and a control section 12 shown in FIG. 2 are implemented. Here, a part of the function of the control section 12 is implemented by a JavaScript program executed by the CPU 1.

The Input device 3 is a user interface such as a mouse, a keyboard, and a touch panel and converts operation by the user into an input signal so as to permit control of the operation of the control section 12. The output device 4 constructed from a monitor or the like displays screen information outputted from the control section 12, in a manner permitting visual recognition.

The transmission and receiving section 11 receives an electronic mail or various screen information (e.g., a mail browsing screen and a list screen for seat mails or received mails) from the WEB mail server 20 and then stores the data into the storage device 2 through the control section 12. Further, the transmission and receiving section 11 transmits to the WEB mail server 20 an electronic mail generated by the user by using the input device 3.

The control section 12 controls: storing or extraction of information into or from the storage device 2; display operation of the output device 4 (output of information to the output device 4); and input and output of information to and from the security server 70. Specifically, the control section 12 stores, into the storage device 2, information such as an electronic mail received from the WEB mail server 20 and a security test result received from the security server 70 or, alternatively, displays such data through the output device 4 in a manner permitting visual recognition. Further, on the basis of an input signal from the input device 3 generated in association with operation by the user, the control section 12 controls the output device 4 so as to display or change a display screen. Furthermore, on the basis of an input signal from the input device 3 generated in association with operation by the user, the control section 12 controls the transmission and receiving section 11 so as to control transmission and receiving of information such as an electronic mail to and from the WEB mail server 20. Further, when an input signal from the input device 3 generated in association with operation by the user satisfies a predetermined condition, the control section 12 requests the security server 70 to test the security of the first link information contained in an electronic mad text and then receives a reply (a security test result) for this from the security server 70.

Here, it is preferable that security test request concerning the first link information, receiving of the test result, and display of the test result performed in the control section 12 are implemented by executing a JavaScript program. Further, it is preferable that tire JavaScript program is transmitted from the WEB mail server 20 to the terminal device 10 together with the electronic mail or the electronic mail list.

FIG. 3 is a diagram showing an example of configuration of the WEB mail server 20 according to an embodiment of the present invention. As shown in FIG. 3, the WEB mail server 20 includes an extraction section 21 and a screen generation section 22 implemented when a program in a storage device (not shown) is executed by the CPU.

When receiving a mail browsing request together with authentication, from the user's the terminal device 10 through the network 100, the WEB mail server 20 reads mail data that has been received in the mail address of the user corresponding to the authentication information used for authentication and that is stored in the mail server 30. Then, the WEB mail server 20 generates display screen data for the WEB mail and then transmits the generated data to the terminal device 10. Here, the mail server 30 receives and stores therein the mails transmitted from other mail servers (not shown) through the network 100 to users' mail addresses administered by the mail server 30.

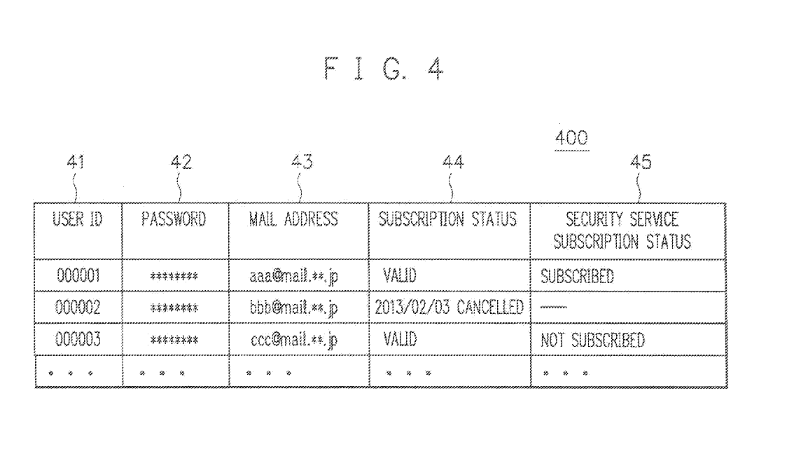

On the basis of user information transmitted from the terminal device 10, the extraction section 21 performs authentication of the user. At that time, with reference to the user information D/B 40, the extraction section 21 judges approval or refusal of authentication of the user. FIG. 4 is a diagram showing an example of structure of user information 400 recorded in a user information D/B 40 according to an embodiment. In the user information 400, a user ID 41, a password 42, a mail address 43, an admission status 44, and a security service subscription status 45 are record in a mutually related manner. The user ID 41 and the password 42 constitute an identifier properly imparted to a user and uniquely determining the user information 400 corresponding to the user. The mail address 43 indicates the mail address of a user identified by the user ID 41. The admission status 44 contains information indicating whether the admission status of a user identified by the user ID 41 is valid. The security service subscription status 45 contains information indicating whether a security test service according to the present embodiment is to be executed.

The extraction section 21 searches the user information D/B 40 by using user information (such as a user ID and a password) transmitted from the terminal device 10. Then, when any user information 400 agreeing with the user information (the user ID and the password) is registered in the user information D/B 40, the user is authenticated (in the case of not being registered, the user is not authenticated).

In response to a request from the user (the terminal device 10) having been authenticated, the extraction section 21 acquires an electronic mail having been received for the user, from the mail server 30 with adopting as a key the user ID 41 or the user's mail address 43, and then outputs the data to the screen generation section 22. Here, the mail data D/B 50 stores therein electronic mails related to each user ID 41 or each user's mail address 43 and the mail server 30 extracts from the mail data D/B 50 an electronic mail requested with adopting as a key a user ID 41 or a user's mail address 43.

The screen generation section 22 generates screen information containing the extracted electronic mail (e.g., a browsing screen for a received mail and a list screen for received mails and sent mails), for example, in an HTML (Hyper Text Markup Language) form. Specifically, the screen generation section 22 extracts first link information (such as a URL) contained in the electronic mail text and then forms a hyperlink to which the action of accessing the link destination is attached to text data or image data indicating the first extracted link information. The screen generation section 22 generates, in an HTML form, screen information used for displaying the electronic mail including the hyperlink. Here, the screen information generation processing may be implemented by executing a later-described JavaScript program on the terminal device 10 side.

When a predetermined operation condition (referred to as a first condition, hereinafter) is satisfied, the screen generation section 22 inquires of the security server 70 about the security of the first link information (a link destination connected in accordance with this) and then transmits a JavaScript (a script language operating on the browser) program in which the operation of displaying the obtained stability analysis result is set forth, to the terminal device 10 in a manner of being attached to screen information (a mail browsing screen) used for displaying the electronic mail. It is preferable that the operation set forth as the first condition is one causing no substantial load to the user and capable of identifying the first link information. For example, when a mouse is employed as the input device 3 (the user interface), the first condition may be set forth as the operation of continuing to hover for a time longer than a predetermined time the mouse over a link destination (referred to as a displayed link destination, hereinafter) displayed in the mail text. Alternatively when a touch panel is employed as the input device 3 (the user interface), the first condition may be set forth as the operation of continuing to perform long tap on the displayed link destination for a time longer than a predetermined time or, alternatively, of performing flick (swipe). Further, it is preferable that the security test result obtained from the security server 70 is displayed in a form of being related to the displayed link destination. For example, a speech balloon is popped up that is linked to the displayed link destination and contains the security test result.

In the terminal device 10, the control section 12 implemented by the WEB browser outputs, to the output device 4, image information generated by the screen generation section 22.

It is preferable that the proxy server 60 is provided between the terminal device 10 and the security server 70. The proxy server 60 caches: the first link information (such as the URL) of a WEB site the test of whose security has been requested from the terminal device 10 to the security server 70; and the test result of the security. Further, in response to a security test request for the same link information as the first link information having been cached, the security server 70 returns the corresponding security test result in the cache.

It is preferable that the data in the cache in the security server 70 is deleted in accordance with a predetermined condition for the purpose of size reduction of the cache. For example, when the elapsed time after caching is adopted as the deletion condition for the cache, the cache is cleared when a predetermined duration (e.g., a predetermined short time such as 5 minutes) is elapsed. In this case, old test results in which the predetermined duration has been elapsed are discarded. Thus, the newest information can be provided to the terminal device 10.

Alternatively, the security server 70 may delete the test results in the cache at each time that the number of electronic malls whose security test has been requested from the terminal device 10 reaches a predetermined number (e.g., one). In this case, the terminal device 10 transmits to the security server 70 the first link information serving as a test target and the identifier of the electronic mail including the first link information. The security server 70 registers the security-tested link information and the identifier of the electronic mail in a mutually related manner and then recognizes the number of electronic mails whose security test has been requested, on the basis of the identifier of the electronic mail transmitted at the time of request of security test. Also in this case, old test results are discarded in accordance with the number of times of the tests. Thus, the newest information can be provided to the terminal device 10.

In the security server 70, information concerning threat vectors related to files, WEB sites, mails, networks, and the like and data (reputation information) acquired from sensors (not shown) in the world are recorded in a mutually related manner in the security information D/B 80. With reference to the security Information D/B 80, the security server 70 tests the security (the reliability) of the first link information transmitted from the terminal device 10. Specifically, the security information D/B 80 records therein: known or new malware-based threat information; threat information concerning IP addresses, network ports, and communication protocols; and threat information concerning URLs, WEB domains, and DNS servers. The security information D/B 80 is preferably constructed from a storage device built in the security server 70, an external server, or an NAS.

As the security server 70 and the security information D/B 80, a security service such as GTI (Global Threat Intelligence) provided by a security vendor may preferably be employed.

With reference to the information in the security information D/B 80, the security server 70 tests the first link information (the security or the reliability of this) transmitted from the terminal device 10 and thereby identifies the contents and the danger of a threat. It is preferable that from a plurality of security levels (also referred to as degrees of security or as scores) prepared in correspondence to the contents and the danger of threats, the security server 70 extract a security level corresponding to the security test result of the first link information. For example, in the security information D/B 80, three security levels consisting of “danger”, “caution”, and “secure” may be set up. In this case, the security server 70 extracts a security level from danger, caution, and secure in correspondence to the test result of the first link information transmitted from the terminal device 10.

Further, it is preferable from plural pieces of category information prepared in correspondence to the contents of threat in the link destination, that the security server 70 extract category information corresponding to the security test result of the first link information. For example, in the security information D/B 80, category information may be registered that identifies “virus malware”, “phishing malware”, “adult content”, or the like classified in accordance with the contents of threat in the link destination. In this ease, from among the Information identifying virus malware, phishing malware, adult content, or the like, the security server 70 extracts one or plural pieces of category information corresponding to the test result of the first link information transmitted from the terminal device 10.

The security server 70 transmits the security level and the category information extracted in correspondence to the security test result, to the terminal device 10 as a result of the requested security test.

It is preferable that the screen generation section 22 of the WEB mail server 20 transmits information (such as image data and text data) used for displaying at least one selected from the security level and the category information extracted in correspondence to the security test result and from guide display information described later, to the terminal device 10 together with a JavaScript program. By using the information acquired from the WEB mail server 20, the terminal device 10 performs display in correspondence to the security test result acquired from the security server 70.

For example, the terminal device 10 holds, in the storage device 2, texts and symbols expressing various security levels and various category information and displays a text and a symbol corresponding to the security level and the category information acquired from the security server 70. Further, it is preferable that the terminal device 10 holds, in the storage device 2, guide display information used for guiding the user to a link destination where a service is provided in correspondence to a particular security level or particular category information. The terminal device 10 displays the guide display information corresponding to the security level and the category information acquired from the security server 70. Here, for example, the guide display information contains second link information serving as a text, a symbol, or a hyperlink used for guiding the user to a link destination where a security service is provided. For example, when the security level transmitted in correspondence to the security test result is at or below a predetermined level (e.g., the security level is “danger” or “caution” in a case that the security levels are set up in three levels of “danger”, “caution”, and “secure”), second link information used for accessing a WEB site (a WEB page) where a security service is introduced or purchased is displayed on the terminal device 10 as the guide display information. For example, the second link information indicates an identifier such as a URL and an IP address or alternatively a hyperlink to this, which is used by the user (the terminal device 10) accessing a WEB site (a WEB page), a file, a network, another terminal device 10, or the like.

Further, it is preferable that the text data, the image data, and the guide display information recorded in a manner of being related to the security level or the category information are transmitted from the WEB mail server 20 to the terminal device 10 in a manner of being attached to the electronic mail text as a JavaScript program described above or alternatively at an arbitrary timing. Alternatively, such information may be transmitted from the security server 70 to the terminal device 10 as the security test result. In this case, it is preferable that the security server 70 selects the text data, the image data, and the guide display information corresponding to the security test result and then transmits the selected data and information to the terminal device 10.

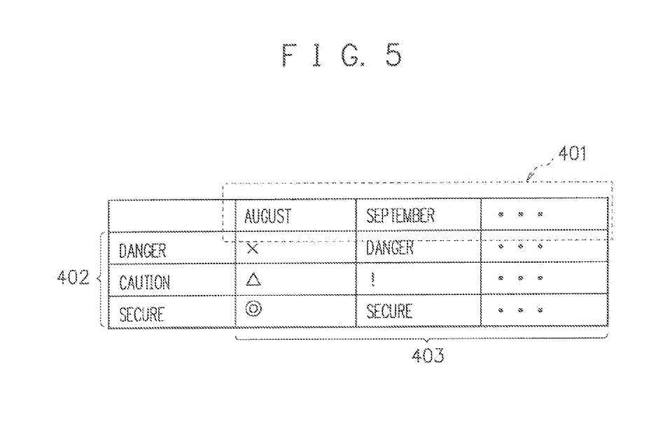

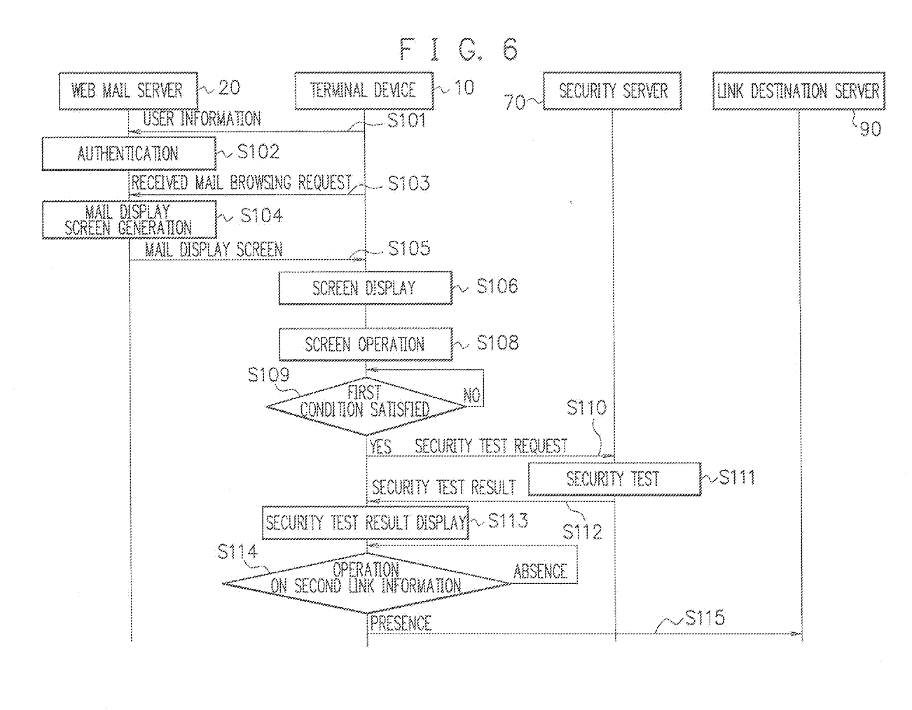

It is preferable that the mode of displaying the security level (referred to as a security level display mode, hereinafter) is changed in accordance with a predetermined condition (referred to as a second condition, hereinafter). FIG. 5 shows a modification of the security level display mode. In FIG. 5, a display period in the year is defined as a second condition 401. Then, a display mode 403 for each security level 402 is shown for each period in the year. In this example, the display mode 403 is set up for each month of August, September, . . . . Specifically, when the security level 402 is “danger”, “x” is displayed in August and “DANGER” is displayed in September. When the security level 402 is “caution”, “A” is displayed in August and “!” is displayed in September. When the security level 402 is “secure”, “⊚” is displayed in August and “SECURE” is displayed in September. As such, when the display period in the year is set forth as the second condition, decrease in the attentiveness to the security display (mannerism) can be avoided. Further, the display mode for the security level to be changed in accordance with the second condition may be at least any one of: the size, the color, and the frame shape of a speech balloon; the character size; the character font; and the like.

The security level display mode may be changed depending on the utilization situation of the second link information. For example, the security level display mode may be changed depending on the number, the percentage, or the like of reduction in the number of accesses that the WEB site is visited by using the second link information (the link to a security service). In this ease, it is preferable that the WEB mail server 20 acquires the utilization situation of the second link information from the vendor operating the security server. Further, it is preferable that the security level display mode and the second condition which is a changing condition for this are transmitted to the terminal device 10 by the WEB mail server 20 in a manner of being attached to the electronic mail text as a JavaScript program described above or alternatively at an arbitrary timing.

Further, it is preferable that security level display mode contains a portion to be changed in accordance with the second condition (the first security level display information) and a portion (the second security level display information) not to be changed. For example, as shown in FIG. 12, a marked portion (image information 201) where mannerism is expected to occur is changed in accordance with the second condition. In contrast, the displayed contents in a text portion (text information 202) indicating the security level are maintained intact regardless of the second condition.

Similarly to the security level display mode, it is preferable that the mode of displaying the category information also contains a portion to be changed in accordance with the second condition and a portion where the displayed contents are to be maintained Intact regardless of the second condition. For example, with reference to the category display information 205 shown in FIG. 12, a marked portion where mannerism is expected to occur is changed in accordance with the second condition. In contrast, the displayed contents in a text portion indicating the security level are maintained intact regardless of the second condition.

### Operation of Mail Distribution System

Next, with reference to FIGS. 6 to 13, operation of the mail distribution system according to the present invention is described below. FIG. 6 is a sequence diagram showing an example of mail distribution operation and security test operation (a security check method) according to an embodiment.

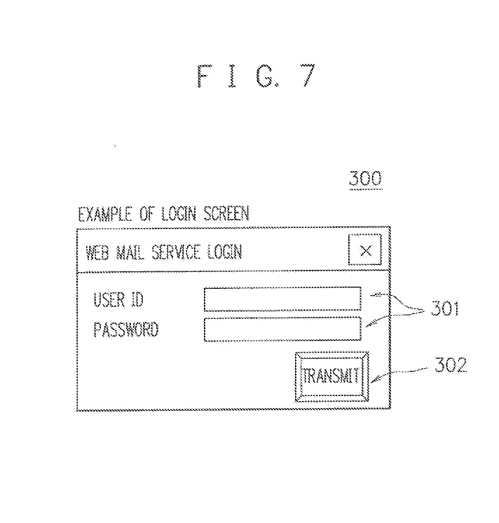

Although not shown, the terminal device 10 displays a login screen based on the login screen information received from the WEB mail server 20. Specifically, when a URL to the WEB mail server 20 is inputted through the input device 3 to the browser in association with operation or the like by the user, the terminal device 10 transmits a login screen request to the WEB mail server 20. When receiving the login screen request from the terminal device 10, the screen generation section 22 of the WEB mail server 20 transmits, to the terminal device 10, login screen information in which fields used for inputting a user ID and a password are provided. On the basis of the received login screen information, the terminal device 10 displays a login screen 300 shown in FIG 7. The login screen 300 includes user information input fields 301 and a transmit button 302.

When user information is inputted through the input device 3 in association with operation by the user and then transmission operation is performed, the user information is transmitted from the terminal device 10 to the WEB mail server 20 (step S101). For example, when a user ID and a password are inputted in the user information Input fields 301 in the login screen 300 and then the transmit button 302 is pressed in association with operation such as click and tap, user information (such as the user ID and the password) is transmitted from the terminal device 10 to the WEB mail server 20 (step S101). As such, the user ID and the password are transmitted as user information to the WEB mail server 20.

With reference to the user information D/B 40, the WEB mail server 20 judges authentication permission or refusal of the user information received from the terminal device 10 (step S102). Here, when information agreeing with the user information received from the terminal device 10 is registered in the user information D/B 40 and its subscription status is valid, the WEB mail server 20 permits authentication of the terminal device 10 having transmitted the user information (mail browsing valid). On the other hand, when the user information is not registered in the user information D/B 40 or alternatively the subscription status is invalid, authentication is not permitted (mail browsing invalid). This authentication result Is notified (not shown) to the terminal device 10. From now on, in response to a request from the terminal device 10, mail service for the authenticated user ID (the mail address) is started.

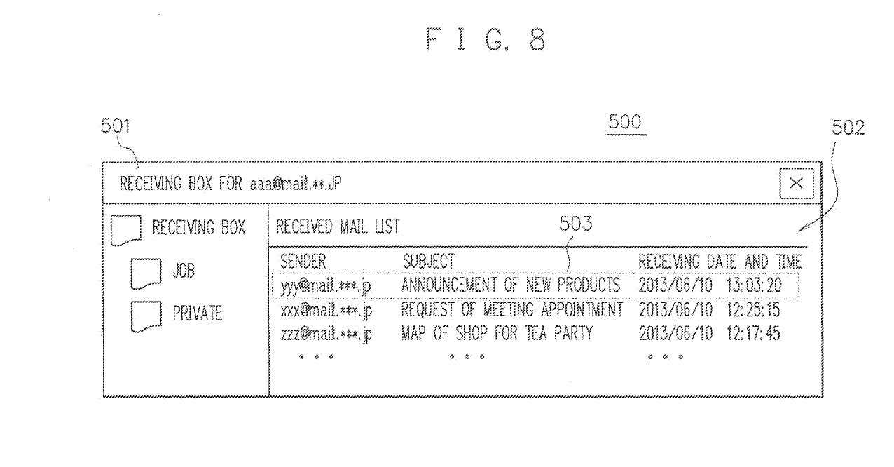

On the basis of the mail list screen information transmitted from the WEB mail server 20 in response to a mail list screen request from the terminal device 10 whose authentication has been permitted, the terminal device 10 displays a mail list screen (not shown). Specifically, in response to operation by the user, the terminal device 10 transmits a mail list screen request (not shown) to the WEB mail server 20. In response to the mail list screen request, with reference to the user information D/B 40, the WEB mail server 20 identifies a marl address corresponding to the user information (such as the user ID) whose authentication has been permitted and then generates list screen information for the mails received in the address. Here, the WEB mail server 20 reads from the mail data D/B 50 the information concerning a receiving box in which mails received in the user's mail address is stored, and then generates received mail list screen information in an HTML form or the like in which the subject name, the transmission source address, and the receiving date and time of each mail are described. The WEB mail server 20 transmits the generated list screen information to the terminal device 10. On the basis of the list screen information received from the WEB mail server 20, the terminal device 10 displays a received mail list screen 500 shown in FIG. 8. The received mail list screen 500 includes: a receiving box name 501 used for identifying the receiving box of a displaying target; and a received mail list 502. The received mail list 502 displays mail information 503 uniquely specified by the subject name, the transmission source address (the sender), the receiving date and time, and the like. Here, the mail list screen display request from the terminal device 10 may be transmitted simultaneously to the user authentication request. In this case, after the user authentication, the WEB mail server 20 transmits the mail list screen information to the terminal device 10.

In addition to the mail list screen related to the user (the mail address), screens such as a transmission box, a temporary save box, and a delete folder for displaying information necessary for the mail service may be displayed after the user authentication. Here, the screen for received mails is described below in detail and description of other screens are omitted.

When the terminal device 10 transmits to the WEB mail server 20 a browsing request for a received mail, a mail display screen for displaying the details of the requested received mail is transmitted from the WEB mail server 20 (steps S103, S104, and S105).

Specifically, when the input device 3 is operated so that any one piece of the mail information 503 is specified in the received mail list screen 500, a received mail browsing request containing a mail identifier used for Identifying the specified mail Is transmitted from the terminal device 10 to the WEB mail server 20 (step S103).

On the basis of the mail browsing request, the WEB mail server 20 generates a mail display screen for displaying the specified mail text (step S104). Specifically, the WEB mail server 20 refers to the receiving box corresponding to the user stored in the mail server 30 and then reads the mail text data corresponding to the mail identifier contained in the mail browsing request. Here, the mail text data may contain the transmission destination address, the transmission source address, the subject name, and the like. From the mail text data, the WEB mail server 20 extracts as the first link information a description corresponding to a URL (alternatively, a mail address or the like). For example, on the basis a description such as “http://” and “https://”, the WEB mail server 20 extracts the first link information. After that, the WEB mail server 20 attaches to the extracted URL the function of a hyperlink to the URL (also including coloring, underlining, and the like for the displayed characters) so as to generate mail text display data in an HTML form or the like. Here, the description has been given for a case of a text format in which the function of a hyperlink is not attached to the URL in the mail text data. Instead, the mail text data may be transmitted in an HTML form from the sender of the mail. In this case, the WEB mail server 20 neither attaches the hyperlink function nor converts the format into an HTML form, and extracts as the first link information the URL contained in the source in an HTML form.

Here, in some cases, the source code of the mail text display data contains both of a displayed link destination (such as a URL) displayed on the screen; and a link destination (such as a URL) adopted as the actual connection destination when predetermined operation (such as double click) is performed on the displayed link destination. In such a case, the link destination indicated by the displayed link destination and the link destination indicated by the connection destination disagree with each other in some cases. Thus, it is preferable that the link destination indicating the actual connection destination is extracted as the first link information.

When predetermined operation (such as mouse over) is performed on the displayed link destination, the WEB mail server 20 requests the security server 70 to test the security of the first link information, then generates in JavaScript a program of displaying the obtained information, for example, in a pop-up manner, and then attaches the program to the mail text data. Alternatively, the JavaScript program described above may be generated with adopting both of the displayed link destination and the link destination for actual connection, as the first link information serving as the target of security test. The attachment of the JavaScript program may be performed selectively at any one position where the first link information is described or, alternatively, at all positions where the first link information is described.

The JavaScript program described above may display the security level, the second link information, and the category serving as a security test result, by using individually corresponding symbols. Further, when the second link information (a WEB site adopted as the connection destination indicated by this) corresponds to a plurality of categories, a plurality of category symbols are used in some cases. With taking this case into consideration, it is preferable that the WEB mail server 20 transmits to the terminal device 10 the mail text display data in a state that a plurality of symbols corresponding to the second link information are attached. Here, it is preferable that the symbol (or a set of the symbols) corresponding to each of the security level and the second link information, especially a set of the symbols of security level, is changed into any other symbol (or symbols) when the above-mentioned second condition (e.g., a duration such as one month and the number, the percentage, or the like of reduction in the number of accesses that the home page is visited by using the second link information (the link to a security service)) is satisfied. This can avoid a situation that the user gets familiar with the existing symbol so as to overlook caution and danger.

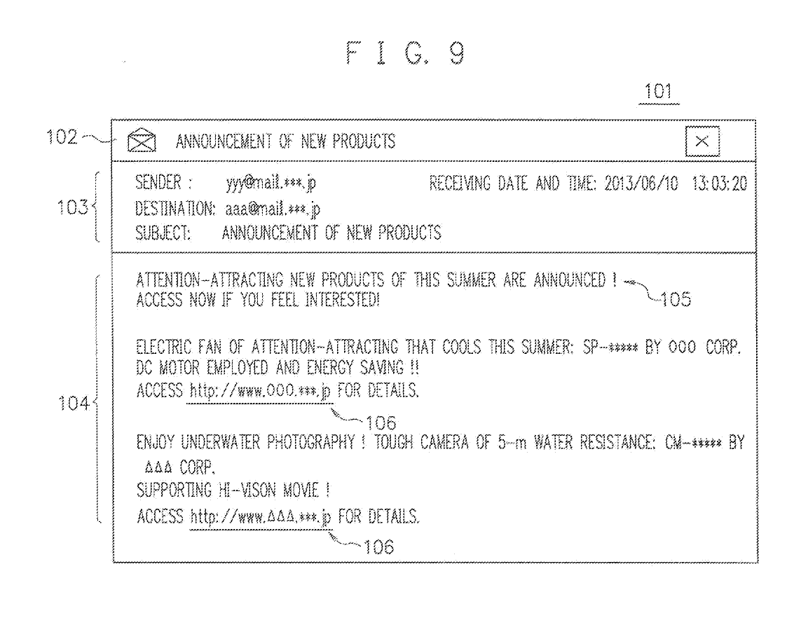

The WEB mail server 20 transmits, to the terminal device 10, the mail display screen information in an HTML form to which the JavaScript program is attached (step S105). By using the browser, on the basis of the mail, display screen information, the terminal device 10 displays the screen where the text of the electronic mail is described and, at the same time, executes the JavaScript program (step S106). FIG. 9 is a diagram showing an example of a mail text display screen 101 according to the present invention. With reference to FIG. 9, the mail text display screen 101 includes a subject name 102, mail identification information 103, and a mail text 104. The mail identification information 103 contains information such as the sender, the destination, the subject name, the receiving date and time, and the like of the electronic mail, which is used for uniquely specifying the mail. The mail text 104 contains text information 105 in the form of text data as well as a displayed link destination 106 in the form of a hyperlink.

During the time that the mail text display screen 101 is displayed, the JavaScript program is executed so that operation satisfying fee first condition is awaited (steps S108 and S109).

When predetermined operation is performed through the input device 3 on the displayed link destination described in the electronic mail text, the terminal device 10 transmits to the security server 70 a security test request containing the first link information (such as a URL identifier) used for identifying a link destination (such as a URL) serving as a connection destination corresponding to the displayed link destination (Yes at step S109; S110). Here, for example, in a case that the input device 3 is a mouse, as the predetermined operation adopted as a trigger for the security test request, such operation is preferable that the cursor (a pointer) is maintained on a displayed link destination displayed on the screen for a predetermined duration (such as 0.5 second). Alternatively, in a case that the input device 3 is a touch panel, tap at the first time is preferable as the predetermined operation adopted as a trigger for the security test request. Alternatively, the security test request may be performed with adopting as a trigger an event that a finger is detected within a predetermined distance in the normal line direction above the touch panel surface. The operation adopted as a trigger of security test request may arbitrarily be set up. However, it is preferable that operation used for accessing the link destination is excluded. In other words, it is preferable that operation different from access operation to the link destination is employed as operation adopted as a trigger of security test request. For example, in a ease that access to a link destination corresponding to the displayed link destination is triggered by double-click on the displayed link destination, security test request is performed by operation different from the double click to the displayed link destination. Since requests security test is performed by operation different from the operation used for accessing the link destination, on the basis of the security test result, the user can determine the necessity or non-necessity of connection to the link destination before performing the operation of connection to the link destination.

When receiving a security test request from the terminal device 10, the security server 70 refers to the security information D/B 80 and thereby judges the security level of a link destination identified by the first link information contained in the security test request (step S111). For example, the security level may be in two levels consisting of secure=⊚) and possible danger=x or, alternatively, in three or more levels consisting of secure=1, caution=2, and danger=3. Further, in a case other than “secure”, the security server 70 judges also the category such as possible adult content=A, possible virus=B, possible vulnerability=C, and possible phishing=D in correspondence to the danger (or the caution) of the link destination (such as a homepage) corresponding to the first link information.

The security server 70 returns the security test result containing the security level judged about the first link information and the category of the link destination (such as a homepage) corresponding to the first link information, to the terminal device 10 having transmitted the security test request (Step 112).

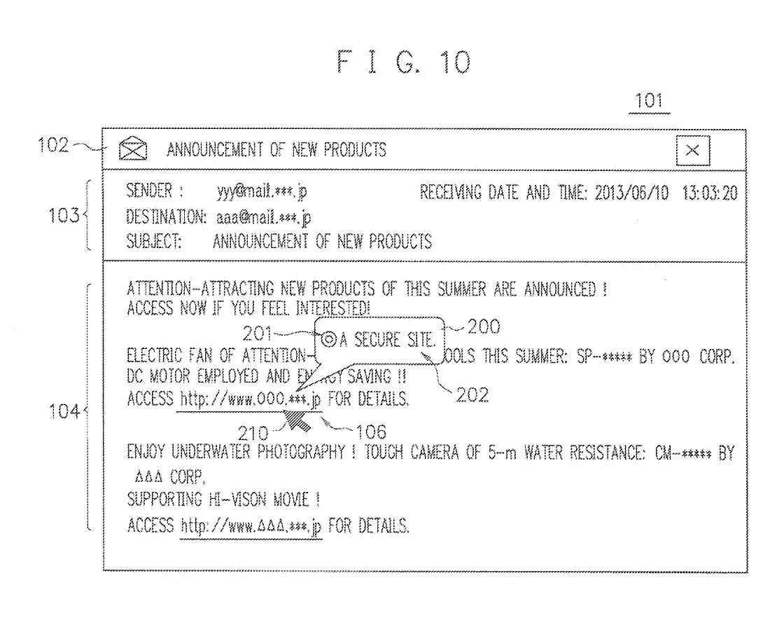

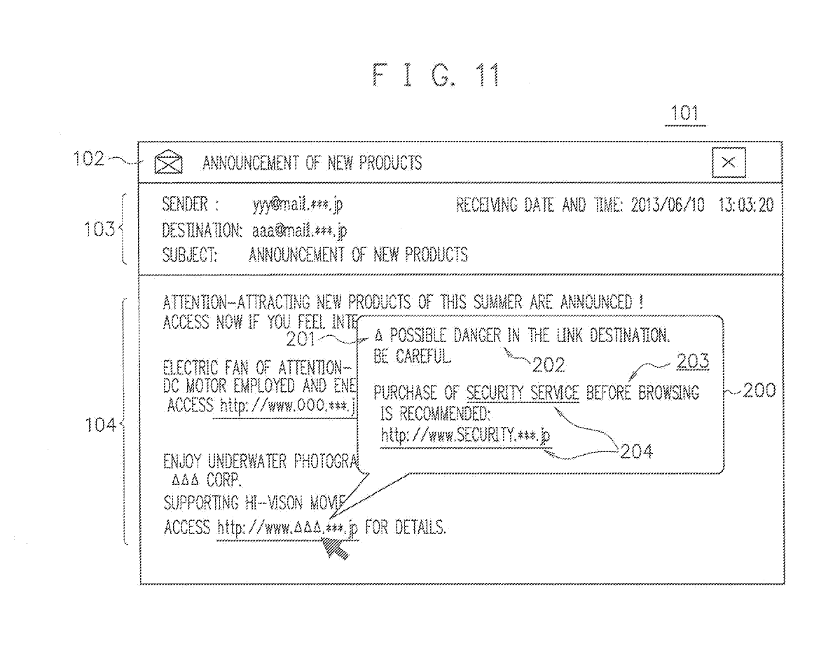

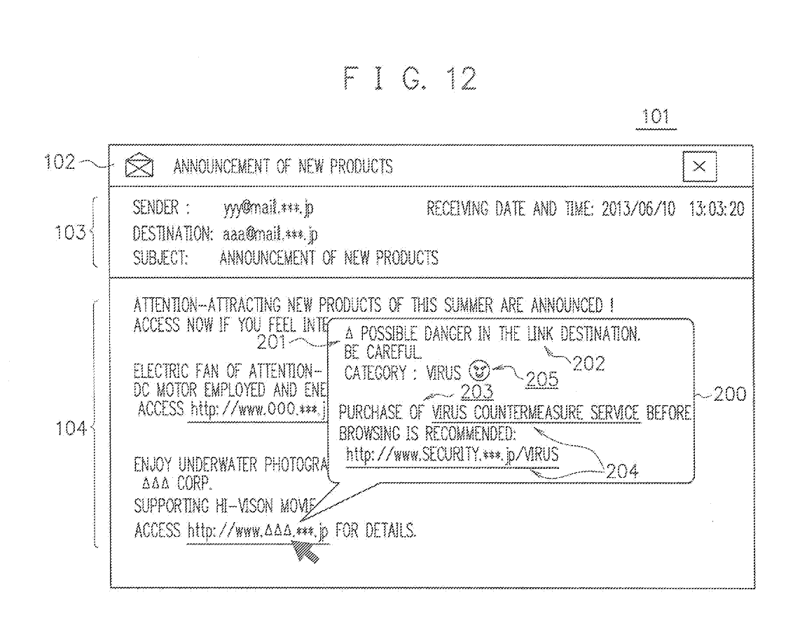

When receiving the security test result, the terminal device 10 displays a screen (referred to as a security test result display screen 200, hereinafter) based on the security level and the category information contained in the security test result (step S113). FIGS. 10 to 12 show an example of the security test result display screen 200. As shown in FIG. 10 to 12, as an example, it is preferable that the security test result display screen 200 is displayed within a speech balloon linked to a displayed link destination 106 on which a pointer 210 is maintained in a mouse-over state. The security test result display screen 200 displayed within the speech balloon contains any one of image Information 201 (also referred to as a symbol) and text information 202 indicating the security level corresponding to the test result. Here, the image information 201 corresponds to the display mode 403 corresponding to the security level shown in FIG. 5 and may be changed in accordance with the second condition 401. For example, when the security level is judged as “secure” in the security test, as shown in FIG. 10, “⊚” is displayed as the image information 201 and “A secure site.” is displayed as the text information 202. Alternatively, when the security level is judged as “caution” in the security test, as shown in FIGS. 11 or 12, “Δ” is displayed as the image information 201 and “Possible danger in the link destination. Be careful,” is displayed as the text information 202.

Further, as shown in FIGS. 11 or 12, it is preferable that the terminal device 10 displays guide display information 203 corresponding to the security level or the category information received as the security test result, in a manner of being Included in the security test result display screen 200. The guide display information 203 is set up in correspondence to the security level or the category information and contains: a text or a geometrical figure used for guiding the user to a service or the like necessary for connection to a link destination corresponding to the first link information; or the second link information used for connection to any other service site through a hyperlink. As an example, the guide display information 203 shown in FIG. 11 contains text data “Purchase of security service before browsing is recommended: http:.'7www.security.***.jp”, where “security service” and “http://www.security.***.jp” are set to be hyperlinks as second link information 204. Alternatively, in another example, the guide display information 203 shown in FIG. 12 contains text data “Purchase of virus countermeasure service before browsing is recommended: http://www.security.***.jp/virus”, where “virus countermeasure service” and “http://www.security.***.jp/virus” are set to be hyperlinks as the second link information 204.

It is preferable that the guide display information 203 is displayed when the security level received as a security test result is not of “secure”. For example, a link (an URL) to a homepage where a security service (or, alternatively, software or an application) such as virus countermeasure is introduced or purchase thereof is allowed to be applied is displayed in a manner of being attached in the inside of a speech balloon. Further, in a case that, the category of the first link information has also been known in the security test, a link to a security service correspondence to the category (e.g., a virus countermeasure service in the case of virus malware) may be added.

Further, as shown in FIG. 12, it is preferable that the terminal device 10 displays the category display information 205 indicating the category information received as a security test result, in a manner of being contained in the security test result display screen 200. It is preferable that the category display information contains the category information, that is, text data or image data indicating the contents of the category of the link destination corresponding to the first link information.

In accordance with the security level or the category information contained in the received security test result, the terminal device 10 may perform display with changing at least one of the frame size, the color, the frame shape, the size of the speech balloon.

Further, the terminal device 10 may judge whether the security service provided at the WEB site or the like connected by using the second link information 204 has been purchased, installed, or the like. For example, with reference to the user information D/B 40, the storage device 2, or a plug-in of the browser, the terminal device 10 judges whether the security service has been purchased, installed, or the like. Here, in case of having been purchased or installed, it is preferable that the terminal device 10 displays text data indicating that the security service has been purchased (installed), on the security test result display screen 200.

Further, at the time that the received mail list screen 500 is received from the WEB mail server 20 or, alternatively, at a predetermined timing of transmitting a security test request, the terminal device 10 may inquire of the WEB mail server 20 about whether the user has purchased the security service. Although not shown, it is preferable that in the user information 400, the status of the security service having been purchased or installed by the user is related to the user ID 41. In this case, in response to the inquiry from the terminal device 10, with reference to the user information D/B 40, the WEB mail server 20 returns whether the security service has been purchased. Further, text data indicating whether the security service has been purchased may be transmitted from the WEB mail server 20 to the terminal device 10.

Here, it is preferable that the security test result display screen 200 disappears, for example, when a predetermined time (including the value of 0 second) has been elapsed since the pointer departs from the displayed link destination 106.

It is preferable that various kinds of information such as the text data, the image data, and the hyperlink contained in the security test result display screen 200 is recorded in the storage device 2 of the terminal device 10 in a manner of being related to the security level or the category information. Further, it is preferable that such information is transmitted from the WEB mail server 20 to the terminal device 10 together with the JavaScript program.

During the security test result display screen 200 is displayed, when predetermined operation (such as double click and tap) is performed on the second link information 204, the terminal device 10 performs connection to a WEB site corresponding to the second link information 204 (present at step S114; S115). For example, in response to double click operation on the second link, the terminal device 10 performs connection to a link destination server 90 and thereby receives and displays a WEB site screen where a security service is provided.

According to the present invention, before connection to a WEB site displayed in the form of a link in a mail text, the user can cheek the security of the WEB site. Further, since the security level can be cheeked by means of operation performed before connection operation to the WEB site, the user is allowed to determine the necessity or non-necessity of connection. Further, according to the present invention, the security level and the category information (a classification corresponding to the contents of a threat in the link destination) can be checked and, at the same time, the contents of a security service corresponding to this and guiding means tor this are displayed. Thus, the user can browse the link destination displayed in the mail text after purchasing the corresponding security service so as to take countermeasures.

The present invention has been described above in detail with reference to an embodiment. However, employable configurations in detail are not limited to the embodiment given above. That is, configurations even with changes not departing from the spirit of the present invention are included within the present invention. For example, the symbol, the text, the hyperlink, and the like displayed in the security test result display screen 200 may be not transmitted from the WEB mail server 20 together with the JavaScript program for displaying these, and may be may be transmitted from the security server 70 to the terminal device 10 together with the security test result.

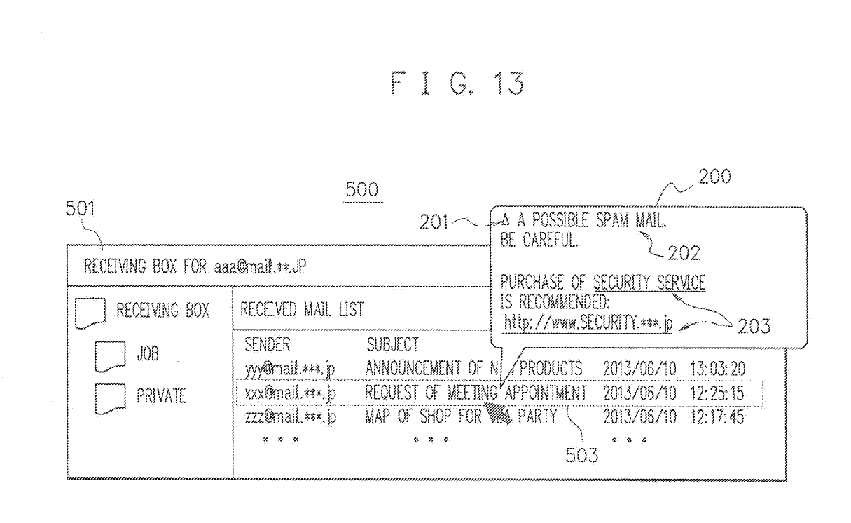

The embodiment given above has been described for a case that security test and display of the security test result are performed with adopting, as a trigger, operation on the displayed link destination 106 in the electronic mail text. However, as long as the first link information can be extracted and test request can be performed on the security server 70, any other operation on the screens may be adopted as a trigger. For example, when predetermined operation is performed on the mail information 503 displayed on the received mail list screen 500 shown in FIG. 8, all pieces of the first link information in the mail text identified by the mail information 503 are extracted and then security tests and display of the security test results are performed similarly to the example given above. Here, the security test result is displayed not on the displayed link destination in the mail text but in the inside of a speech balloon linked to the mail information 503. At that time, it is preferable that among all pieces of the first link information contained in the mail text, the security level or the category information of a first link information piece having the highest degree of danger or threat is displayed representatively. Alternatively, the security levels and the category information of all pieces of the first link information contained in the mail text may be displayed in the form of a list. Further, when a dangerous first Sink information piece whose security level is at or below a predetermined level is detected, this mail may be classified as a spam mail and then, as shown in FIG. 13, a notification of possibility of a spam mail may be displayed in the form of the security test result display screen 200. According to such configurations, a link destination of high danger contained in a mail can be checked before browsing of the mail text. In other words, before browsing of a mail having an unauthorized link, the unauthorized link can be detected in list display at an early stage.

Further, as a security test, the terminal device 10 may request the test of whether the mail text corresponding to the mail information 503 is a spam mail. At that time, it is preferable that the mail information 503 used for Identifying the mail, in particular, the transmission source mail address identifying the sender and the subject name, is transmitted to the security server 70 together with the security test request. In response of the test request, the security server 70 transmits to the terminal device 10 a judgment result indicating whether the mail is a spam mail. As shown in FIG. 13, the terminal device 10 displays the security test result display screen 200 including text data and a symbol indicating the presence of a possibility of a spam mail.

It is preferable that the operation of testing the security of the first link information and the possibility of a spam mail and of displaying the result, which is performed in response to the operation on the received mail list screen 500, is implemented similarly to the example given above by executing the JavaScript program transmitted from the WEB mail server 20.

Here, in the security server 70 and the security information D/B 80, in some cases, update of the data used in the judgment is slower in the spam-mail judgment engine than in the phishing judgment engine. This causes a possibility that an electronic mail is judged as not being a spam mail at the time of receiving by the mail server 30 but is judged as being a spam mail at the time of browsing of the electronic mail. Thus, it is effective that whether the mail is a spam mail is judged by the security server 70 immediately before mail browsing.

### DESCRIPTION OF REFERENCE NUMERALS

10 Terminal device

11 Transmission raid receiving section

12 Control section

20 WEB mail server

21 Extraction section

22 Screen generation section

30 Mail server

40 User information database

50 Mail data database

60 Proxy server

70 Security server

80 Security information database

90 Link destination server

100 Network

200 Security test result display screen

201 Image information

202 Text information

203 Guide display information

204 Second link information

205 Category display information

401 Second condition

402 Security level

403 Display mode

What is claimed is:

1. A terminal device comprising a control section for, when operation on a user interface satisfies a predetermined first condition different from operation of Instructing connection to a WEB site, requesting a security server to test security of a link destination indicated by first link information contained in an electronic mail text, then selecting, from plural pieces of display information, display information corresponding to a security test result obtained in response to the request by the security server, and then displaying the selected display information in a manner permitting visual recognition together with second link information indicating another link destination which is different from the link destination indicated by the first link information.

2. The terminal device according to claim 1, further comprising
a receiving section for receiving: an HTML (Hyper Text Markup Language) file containing the electronic mail text related to the user information; and a JavaScript program containing the first condition, from a WEB mail server authenticated with user information, wherein
on the basis of the JavaScript program, the control section performs security test request for the first link information, selection of display information, and display.

3. The terminal device according to claim 1, wherein
the plural pieces of display information contain plural pieces of security level display information corresponding to security levels of link destinations, and wherein
the control section displays, in a manner permitting visual recognition, security level display information corresponding to a security level indicated by the security test result.

4. The terminal device according to claim 1, wherein
the plural pieces of display information contain plural pieces of category display information corresponding to categories of link destinations, and wherein
the control section displays, in a manner permitting visual recognition, category display information corresponding to a category indicated by the security test result.

5. The terminal device according to claim 1, wherein
plural pieces of the second link information are related to security levels of a link destination, and wherein
the control section displays, in a manner permitting visual recognition, second link information corresponding to a security level indicated by the security test result.

6. The terminal device according to claim 3, wherein
each of the plural pieces of security level display information contains: first security level display information whose displayed contents are changed in accordance with a predetermined second condition; and second security level display information whose displayed contents are maintained intact regardless of the second condition.

7. A mail distribution system comprising:
a WEB mail server In which user information is registered; and
a terminal device according to claim 1, authenticated on the basis of the user information by the WEB mail server.

8. A mail distribution system comprising:
a WEB mail server in which user information is registered; and
a terminal device according to claim 2, authenticated en the basis of the user information by the WEB mail server.

9. A mail distribution system comprising:
a WEB mail server in which user information is registered; and
a terminal device according to claim 3, authenticated on the basis of the user information by the WEB mail server.

10. A mail distribution system comprising:
a WEB mail server in which user information is registered; and
a terminal device according to claim 4, authenticated on the basis of the user information by the WEB mail server.

11. A mail distribution system comprising:
a WEB mail server in which user information is registered; and
a terminal device according to claim 5, authenticated on the basis of the user information by the WEB mail server.

12. A mail distribution system comprising:
a WEB mail server in which user information is registered; and
a terminal device according to claim 6, authenticated on the basis of the user information by the WEB mail server.

13. A WEB mail server comprising
a screen generation section for generating screen information used for displaying an electronic mail, wherein
the screen generation section
transmits to a terminal device, in a manner of being attached to the screen information, a program of when operation on a user interface of the terminal device satisfies a predetermined first condition different from operation of instructing connection to a WEB site, requesting a security server to test security of a link destination indicated by first link information contained in an electronic mail text, then selecting, from plural pieces of display information, display information corresponding to a security test result obtained in response to the request by the security server, and then displaying the selected display information in a manner permitting visual recognition on the terminal device together with second link information indicating another link destination which is different from the link destination indicated by the first link information.

14. A security cheek method comprising:
a step of, when operation on a user interface satisfies a predetermined first condition different from operation of instructing connection to a WEB site, requesting a security server to test security of a link destination Indicated by first link information contained in an electronic mail text; and
a step of selecting, from plural pieces of display information, display information corresponding to a security test result obtained in response to the request by the security server and then displaying the selected display information in a manner permitting visual recognition together with second link information indicating another link destination which is different from the link destination indicated by the first link information.

15. A computer-readable recording medium storing therein a security check program for causing a computer to execute:
a step of, when operation on a user interface satisfies a predetermined first condition different from operation of instructing connection to a WEB site, requesting a security server to test security of a link destination indicated by first link information contained in an electronic mail text; and
a step of selecting, from plural pieces of display information, display information corresponding to a security test result obtained in response to the request by the security server and then displaying the selected display information in a manner permitting visual recognition together with second link information indicating another link destination which is different from the link destination indicated by the first link information.
